(19) United States
(12) Patent Application Publication
(10) Pub. No.: US 2004/0196535 A1
(43) Pub. Date: Oct. 7, 2004

(54) Long wavelength optical amplifier with C-band seed

(75) Inventors: Aydin Yeniay, Strafford, PA (US); Renyuan Gao, Strafford, PA (US)

Correspondence Address: MONTE & MCGRAW, PC, 4092 SKIPPACK PIKE, P.O. BOX 650, SKIPPACK, PA, 19474, US

(73) Assignee: Photon-X, Inc., Malvern, PA

(21) Appl. No.: 10/372,471

(22) Filed: Feb. 21, 2003

(51) Int. Cl. H01S 3/00

(52) U.S. Cl. 359/341.1

(57) ABSTRACT

An L band optical amplifier in disclosed. The optical amplifier includes a signal line which has an input, an output disposed optically downstream of the input, and an amplifying gain medium optically disposed between the input and the output. The optical amplifier further includes a laser optically connected to the first amplifying gain medium and a C band seed pump optically connected to the signal line for directing C band light into the amplifying gain medium.

### FIELD OF THE INVENTION

The present invention relates to optical amplifiers having operating wavelengths longer than main emission peak wavelengths, and more particularly to erbium doped fiber and waveguide amplifiers operating in the long wavelength regime (1560-1620 nm), especially for wavelength division multiplexing (WDM) applications.

### BACKGROUND OF THE INVENTION

Conventional erbium doped fiber amplifiers (EDFA) have been extensively used in optical telecommunications as means to amplify weak optical signals in the third telecommunication window (near 1550 nm) between telecommunication links. Much work has been done on the design of these amplifiers to provide efficient performance, such as high optical gain and low noise figure. However, with the recent enormous growth of data traffic in telecommunications, owing to the Internet, intranets, and e-commerce, new optical transmission bandwidths are required to provide increased transmission capacity in dense wavelength division multiplexing (DWDM) systems.

There are a few solutions to this demand. One proposed solution is to utilize new materials compositions as a host for the fiber gain medium (instead of silica) such as telluride, which may provide broader amplification bandwidth (up to 80 nm). However, the non-uniform gain shape and poor mechanical properties of telluride glass make these amplifiers difficult to implement in the telecom systems. Also, Raman amplifiers can be considered as an alternative solution to high bandwidth demand, since these amplifiers are capable of providing flexible amplification wavelength with a broad bandwidth. However, these amplifiers place restrictions on optical system architectures because of their required designs for efficient performance, such as long fiber length (>5 km), high pump power (>500 mW) and co-pumping configurations. On the other hand, relatively long erbium doped fibers (EDFs) may also provide amplification in the long wavelength range (1565-1625 nm) when they are used with high power pump sources. This range is commonly called “L band”. The conventional range, also known as “C band” is in the wavelength range between 1525-1565 nm.

In principle, L band amplifiers take advantage of the fact that EDFs have higher emission cross-section than absorption cross-section at longer wavelengths. Therefore, for long EDFs, amplified spontaneous emission (ASE) becomes more emphasized at long wavelengths. However, there are still several issues for optimization of L band amplifiers for efficient performance. So far, reported performance of L band EDFAs has been inferior to that of C band EDFAs, with drawbacks as evidenced by higher noise figure (NF) and lower output power and gain. It would be beneficial to provide an L band amplifier with a low noise figure and high output power and gain.

### BRIEF SUMMARY OF THE INVENTION

The present invention also provides an L band optical amplifier. The optical amplifier comprises a signal line including an input, an output disposed optically downstream of the input and an amplifying gain medium optically disposed between the input and the output. The optical amplifier further comprises a laser optically connected to the first amplifying gain medium and a C band seed pump optically connected to the signal line between the input and the amplifying gain medium for directing C band light into the amplifying gain medium.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a schematic drawing of an L band amplifier according to a first embodiment of the present invention.

FIG. 2 is a schematic drawing of an L band amplifier according to a second embodiment of the present invention.

FIG. 3 is a graph showing measured gain and noise figures vs. input signal wavelength for the first embodiment of the present invention.

### DETAILED DESCRIPTION OF THE INVENTION

In the drawings, like numerals indicate like elements throughout. The present invention provides novel techniques and arrangements for improving the performance of L band EDFAs. In general, the present invention utilizes ASE in the C band to provide additional amplification capability in the amplifier. The ASE is generated during signal amplification by a separate C band seed pump. Components are defined to be “optically connected” when light signals can be transmitted between those components.

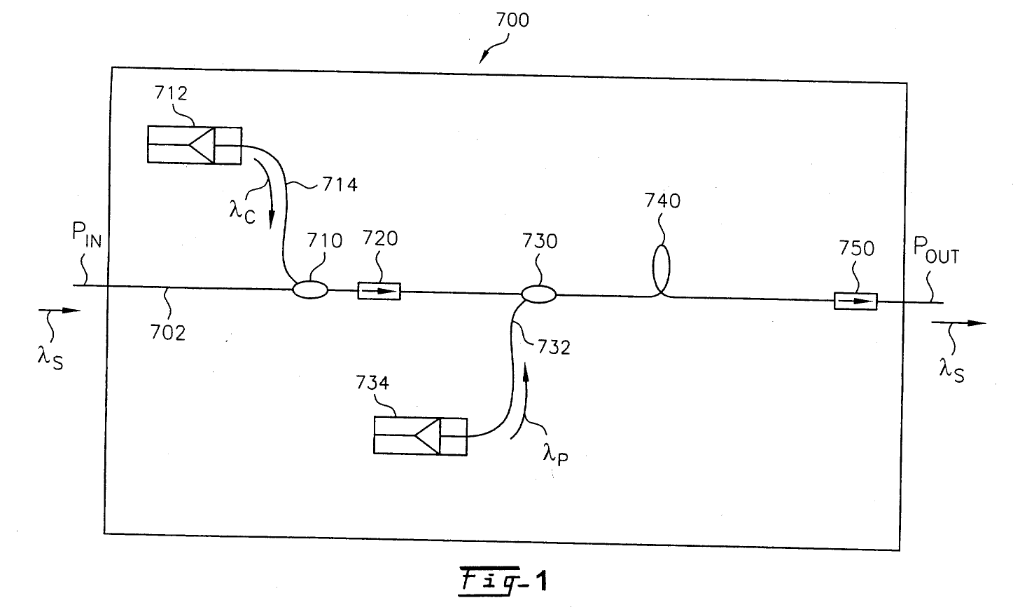

A first embodiment of an L band amplifier 700 according to the present invention is shown schematically in FIG. 1. The amplifier 700 includes a signal line 702 which extends from an input Pᵢₙ at one end of the amplifier 700 to an output Pₒᵤₜ at another end of the amplifier 700. As used herein, the term “optically downstream” is defined to mean a direction along the signal line 702 from the input Pᵢₙ toward the output Pₒᵤₜ. The input Pᵢₙ and the output Pₒᵤₜ are optically connected to each other along the signal line 702 through the amplifier 700. Signal light Xs having at least one, and preferably, multiple wavelengths is transmitted through the amplifier 700 from the input Pᵢₙ to the output Pₒᵤₜ, from left to right as shown in FIG. 1. The wavelengths of the signal light λ_{S} preferably range approximately from 1565 to 1625 nanometers, placing the signal light λ_{S} in the L band. Those skilled in the art will recognize that the signal line 702 can be a fiber, a waveguide, or other light transmitting device.

A C-L band multiplexer 710 is optically disposed in the signal line 702 between the input Pᵢₙ and the output Pₒᵤₜ. The C-L band multiplexer 710 optically connects a tunable C band seed pump 712 to the signal line 702 via a C band pump guide 714. Alternatively, an optical coupler (not shown) can be used instead of the C-L band multiplexer 710. A first optical isolator 720 is disposed in the signal line 702 optically downstream of the C-L band multiplexer 710. The first optical isolator 720 prevents backscattered light and other optical noise from traveling backward along the signal line 702, from the first optical isolator 710 toward the input Pᵢₙ.

A pump-signal multiplexer 730 is disposed along the signal line 702 optically downstream of the first optical isolator 720. The pump-signal multiplexer 730 couples a first end of a pump laser guide 732 to the signal line 702. A second end of the pump laser guide 732 is connected to a pump laser 734. Preferably, the pump laser 734 is a 980 nanometer laser which emits a pump signal λ_{P}, although those skilled in the art will recognize that other wavelengths can be used as well. Also preferably, the pump laser 734 has an output power of at least 100 mW, although those skilled in the art will recognize that the pump laser 734 can have other output powers as well.

A rare earth doped amplifying gain medium 740 is disposed along the signal line 702 optically downstream of the pump-signal multiplexer 730. Preferably, the rare earth is erbium, although those skilled in the art will recognize that other elements, including, but not limited to lanthanum, cerium, praseodymium, neodymium, promethium, samarium, europium, gadolinium, terbium, dysprosium, holmium, thulium, ytterbium, lutetium, and combinations and blends thereof can be used. Although the amplifying gain medium 740 does not have a minimum or maximum length, those skilled in the art will recognize that the length of the amplifying gain medium 740 can be varied, in conjunction with different output powers of the pump laser 734, to provide different amplification gains and/or output powers. While the amplifying gain medium 740 is preferably a fiber, those skilled in the art will recognize that the amplifying gain medium 740 can also be a waveguide or other light transmitting device.

A second optical isolator 750 is disposed along the signal line 702 optically downstream of the amplifying gain medium 740. The second optical isolator 750 prevents backscattered light and other optical noise from traveling backward along the signal line 702, from the second optical isolator 750 toward the amplifying gain portion 740. The second optical isolator 750 is optically connected to the output Pₒᵤₜ of the amplifier 700.

In operation, the signal light λ_{S} having a wavelength band of approximately between 1565 and 1625 nanometers is injected into the amplifier 700 in a first direction at the input Pᵢₙ. The signal light λ_{S} is transmitted along the signal line 702 to C-L band multiplexer 710. The signal light λ_{S} passes through the C-L band multiplexer 710 and along the signal line 702 to the first optical isolator 720. The signal light λ_{S} passes through the first optical isolator 720 to the pump-signal multiplexer 730.

The C band seed pump 712 generates a tunable C band light signal λ_{C}, between 1530 nm and 1570 nm. The C band seed pump 712 can be tuned to generate an optimized C band seed wavelength for transmission toward the amplifying gain medium 740. The C band light signal λ_{S} travels along the C band pump guide 714 to the C-L band multiplexer 720, where the C band light signal λ_{S} enters the signal line 702. The C band light signal λ_{S} then travels along the signal line 702 with the signal light s.

The pump laser 734 transmits a 980 nanometer pump signal λ_{P} along the pump laser guide 732 to the pump-signal multiplexer 730. At the pump-signal multiplexer 730, the signal light λ_{S} and the C band light signal λ_{C} are combined with the pump signal λ_{P} emitted by the pump laser 734. The C band light signal λ_{C} is amplified in the gain medium 740 and suppresses the backward ASE. The amplified C band light signal λ_{C}, as well as the signal light λ_{S} and the pump signal λ_{P}, propagate through the amplifying gain medium 740. The amplified C band light signal λ_{C} and any residual pump signal λ_{P} excite the rare earth element in the amplifying gain medium 740, amplifying the signal light λ_{S}. The C band light signal λ_{C} does not significantly generate ASE in the C band because of the longer wavelength of the C band light signal λ_{C}. As a result, backward ASE is significantly reduced and additional C band pumping by the C band seed is generated, resulting in greater amplification of the signal light λ_{S}.

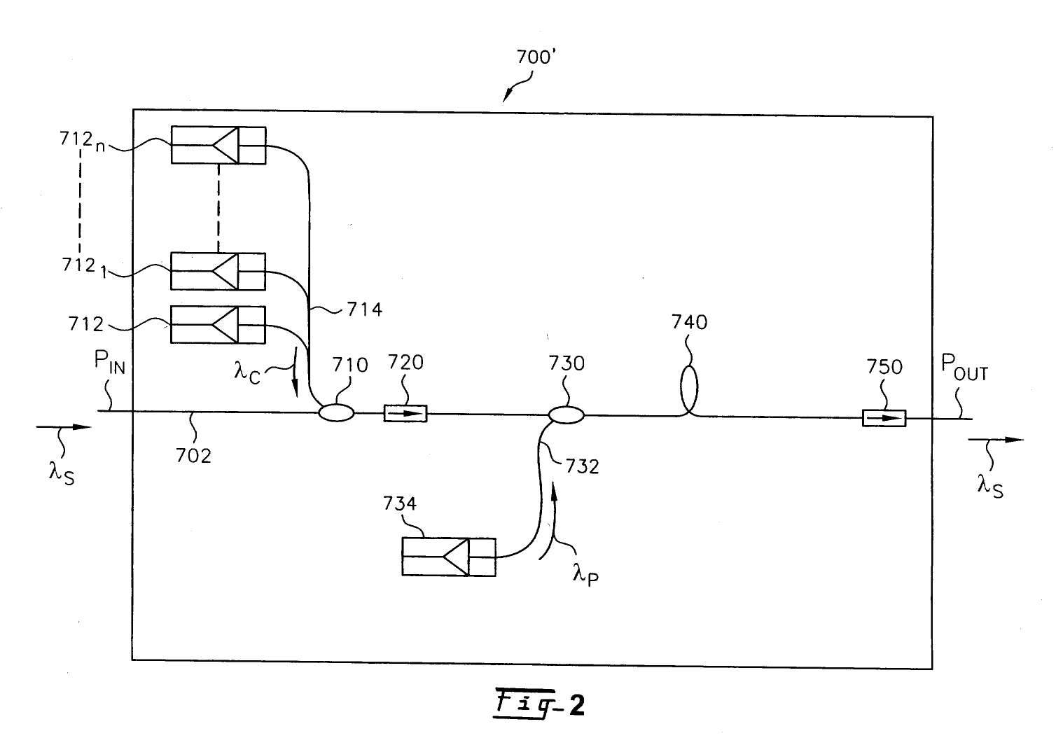

A second embodiment of an L band amplifier 700′ is shown schematically in FIG. 2. The second embodiment is similar to the first embodiment shown in FIG. 1, but with additional C band seed pumps 712₁ through 712ₙ optically connected to the signal line 702. Each C band seed pump 712, 712₁ through 712ₙ generate C band seed at a separate wavelength within the C C band. The multiple wavelengths of C band seed provide additional amplification of the signal light λ_{S} over the C band seed provided by the single C band seed pump 712.

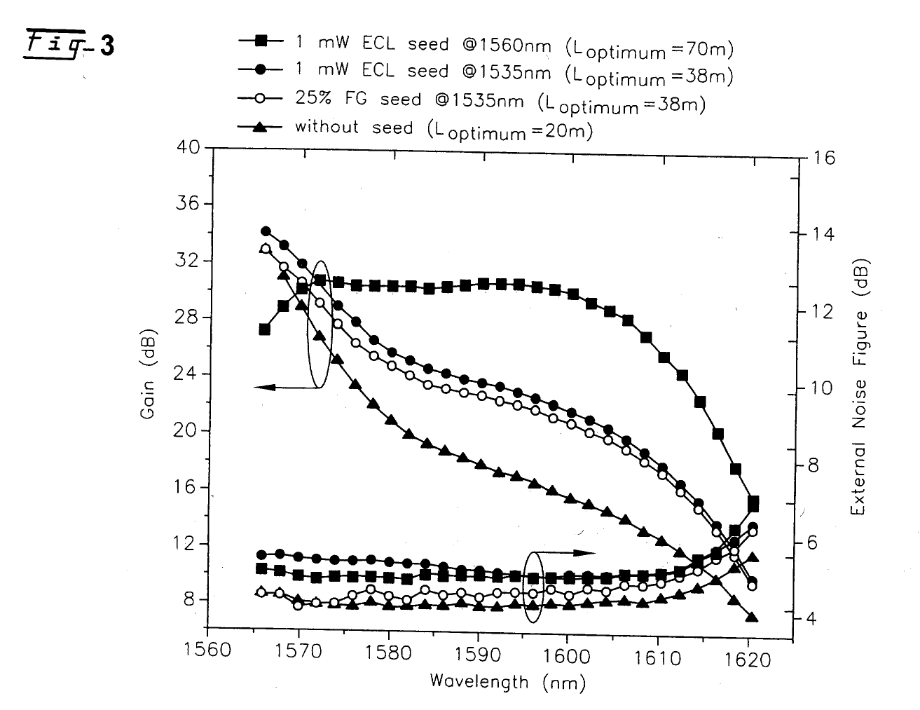

The top two curves on the graph of FIG. 3 (solid square and solid circle) show measured gain vs. input signal wavelength for the first embodiment of the present invention. The third curve (open circle) shows measured gain vs. input signal wavelength for an amplifier using a Bragg grating to reflect C band ASE. The fourth curve (solid triangle) shows measured gain vs. input signal wavelength without any seed. The pump laser 734 used was a 980 nm pump, operating at approximately 180 mW.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An L band optical amplifier comprising:
a signal line including:
an input;
an output disposed optically downstream of the input; and
an amplifying gain medium optically disposed between the input and the output;
a laser optically connected to the amplifying gain medium; and
a C band seed pump optically connected to the signal line for directing C band light into the amplifying gain medium.

2. The L band optical amplifier according to claim 1, wherein the C band seed pump is tunable.

3. The L band optical amplifier according to claim 1, wherein the C band seed pump comprises a plurality of C band seed pumps, each of the plurality of C band seed pumps adapted to emit light of differing wavelengths.

4. The L band optical amplifier according to claim 1, wherein the C band seed pump is optically connected to the signal line between the input and the amplifying gain medium.

5. The L band optical amplifier according to claim 1, wherein the signal line further comprises an optical isolator optically disposed between the input and the amplifying gain medium.

6. The L band optical amplifier according to claim 1, wherein the signal line further comprises an optical isolator optically disposed between the amplifying gain medium and the output.
